(19) United States
(12) Patent Application Publication
(10) Pub. No.: US 2017/0091577 A1
(43) Pub. Date: Mar. 30, 2017

(54) AUGMENTED REALITY PROCESSING SYSTEM AND METHOD THEREOF

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(21) Appl. No.: 14/920,439

(22) Filed: Oct. 22, 2015

(30) Foreign Application Priority Data
Sep. 24, 2015 (CN) 201510614858.1

(51) Int. Cl. G06K 9/46; G06T 7/60; G01B 11/22; G06T 7/40; G06T 7/00; G06T 19/00; G06K 9/52

(52) U.S. Cl. CPC G06K 9/4661; G06T 19/006; G06T 7/60; G06K 9/52; G06T 7/408; G06K 9/4652; G06T 7/0042; G01B 11/22

(57) ABSTRACT

An augmented reality processing system includes a camera and at least one microprocessor in an electronic device. The camera captures surrounding images. The at least one microprocessor determines whether information of a virtual object exists in a surrounding image, creates an actual image, analyzes a light source and shadow angle of the actual image, adjusts a light source and shadow angle of the virtual object to ensure the light source and shadow angle of the virtual object is consistent with the light source and shadow angle of the actual image, and creates a composite image including the virtual object and the actual image. The disclosure further offers an augmented reality processing method.

### FIELD

The subject matter herein generally relates to augmented reality processing systems, and particularly, to an augmented reality processing system capable of processing a light source and shadow angle of a composite image and a related method.

### BACKGROUND

With the recent proliferation of smart telephones, augmented reality technology is being used in various fields. An example of augmented reality technology is a technique of sensing an augmented reality marker from an image taken by a camera and synthesizing a virtual three-dimensional (3D) object according to the sensed marker with the image. Using such a technique, it is possible to make a virtual object that does not exist in reality look like it actually exists on a screen.

### BRIEF DESCRIPTION OF THE DRAWINGS

Implementations of the present technology will now be described, by way of example only, with reference to the attached figures.

FIG. 1 is a diagrammatic view of an example embodiment of an augmented reality processing system.

FIG. 2 is a block diagram of an example embodiment of the augmented reality processing system of FIG. 1.

FIG. 3 is a diagrammatic view of an actual image being created by the augmented reality processing system of FIG. 1.

FIG. 4 is a diagrammatic view of a virtual object being created by the augmented reality processing system of FIG. 1.

FIG. 5 is a diagrammatic view of a preferred shown location P for the virtual object of the augmented reality processing system of FIG. 4.

FIG. 6 is a diagrammatic view of the actual image and the virtual object being analyzed by an analyzing module of the augmented reality processing system of FIG. 2.

FIG. 7 is a diagrammatic view of an example of the light source and shadow angle of the virtual object analyzed by the analyzing module of the augmented reality processing system of FIG. 2.

FIG. 8 is a diagrammatic view of an example of the light source and shadow angle of the first plane I analyzed by the analyzing module of FIG. 7.

FIG. 9 is a diagrammatic view of the light source location of the virtual object of FIG. 8.

FIG. 10 is a diagrammatic view of an example of the coordinate point being confirmed of the virtual object.

FIG. 11 is a diagrammatic view of the virtual object place on the coordinate point of the FIG. 10.

FIG. 12 is a diagrammatic view of an example of a composite image including the actual image and the virtual object.

FIG. 13 is a flowchart of an augmented reality processing method using the augmented reality processing system of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like. In general, the word “module”, as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

The present disclosure is described in relation to an augmented reality processing system. The augmented reality processing system includes a camera, a determining module, an executing module, an analyzing module, and an adjustment module. The camera captures surrounding images. The determining module determines whether information of a virtual object exists in a surrounding image. The executing module creates an actual image. The analyzing module analyzes a light source and shadow angle of the actual image. The adjustment module adjusts a light source and shadow angle of the virtual object to ensure the light source and shadow angle of the virtual object is consistent with the light source and shadow angle of the actual image. The executing module creates a composite image including the virtual object and the actual image. The disclosure further offers an augmented reality processing method.

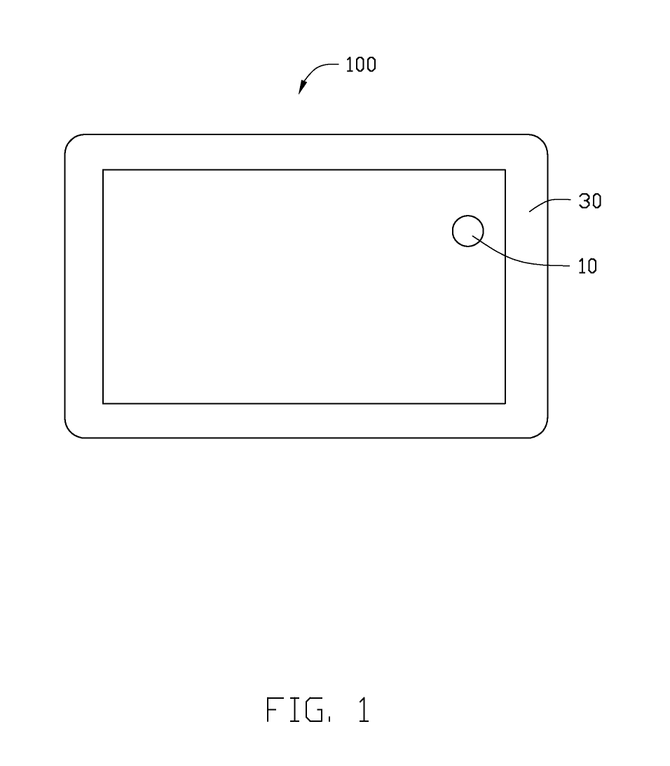

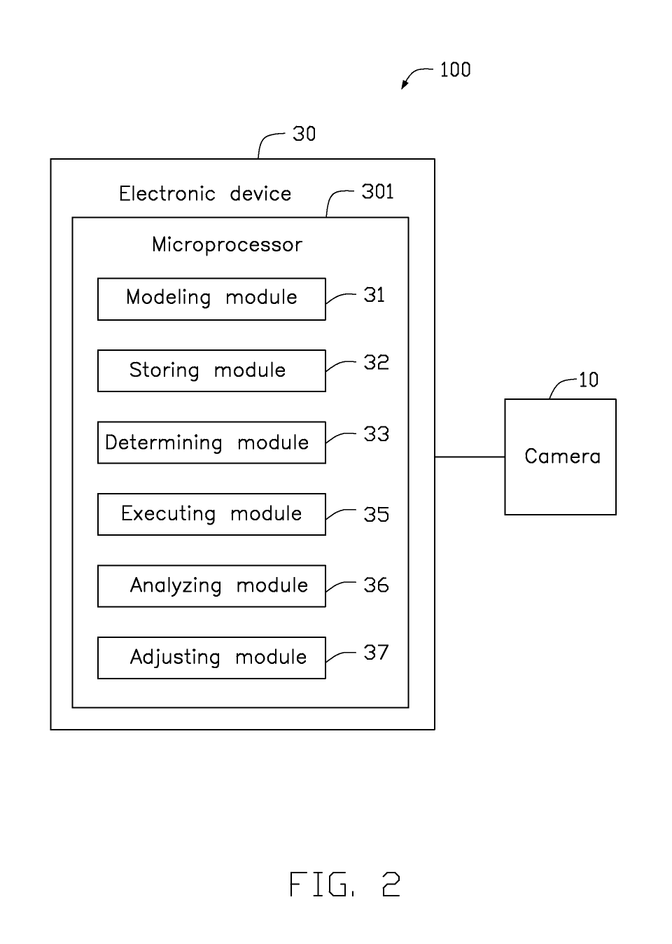

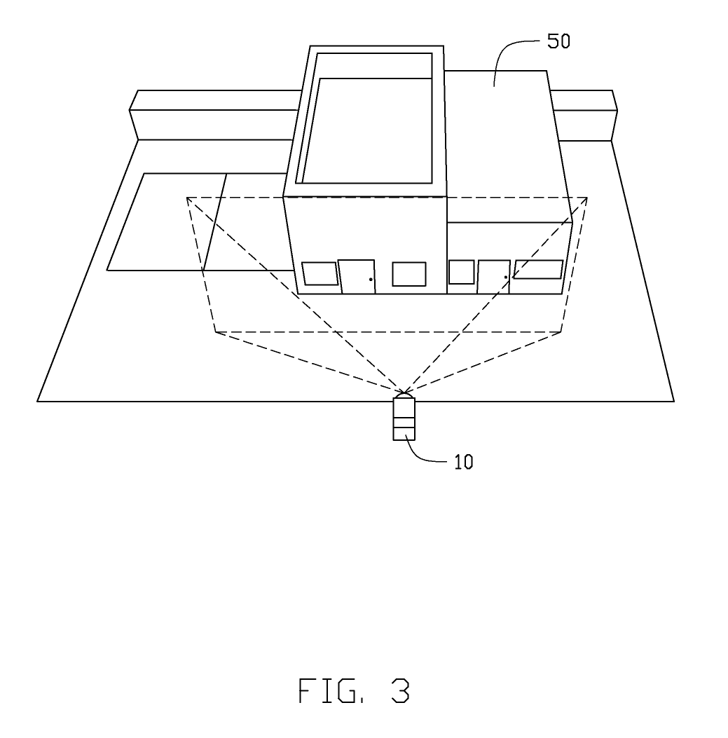

FIGS. 1-2 illustrate an embodiment of an augmented reality processing system 100. The augmented reality processing system 100 can include a camera 10 and an electronic device 30. In at least one embodiment, the camera 10 can be secured to the electronic device 30. The camera 10 can be arranged on the front of the electronic device 30 and can capture images of the surroundings (surrounding images) of the electronic device 30. For example, FIG. 3 is a diagrammatic view of a surrounding images being created by the augmented reality processing system 100 of FIG. 1. In at least one embodiment, the camera 10 can be a depth-sensing camera, and the electronic device 30 can be a notebook or a tablet computer.

The electronic device 30 can include a modeling module 31, a storing module 32, a determining module 33, an executing module 35, an analyzing module 36 and an adjusting module 37. In at least one embodiment, the augmented reality processing system 100, which comprises the modeling module 31, the storing module 32, the determining module 33, the executing module 35, the analyzing module 35 and the adjusting module 37, is comprised of computerized instructions in the form of one or more computer-readable programs stored in the storing module 32 and executed by the at least one microprocessor 301 in the electronic device 30. That is, the modeling module 31, the storing module 32, the determining module 33, the executing module 35, the analyzing module 36 and an adjusting module 37 are in the at least one microprocessor 301. FIG. 2 is only one example of the augmented reality processing system 100, other examples may comprise more or fewer components than those shown in the illustrated embodiment, or have a different configuration of the various components. In at least one embodiment, the storing module 32 can be a storage device, such as a random access memory (RAM) for temporary storage of information, and/or a read only memory (ROM) for permanent storage of information,

In at least one embodiment, the storing module 32 also can be an external storage device, such as an external hard disk, a storage card, or a data storage medium.

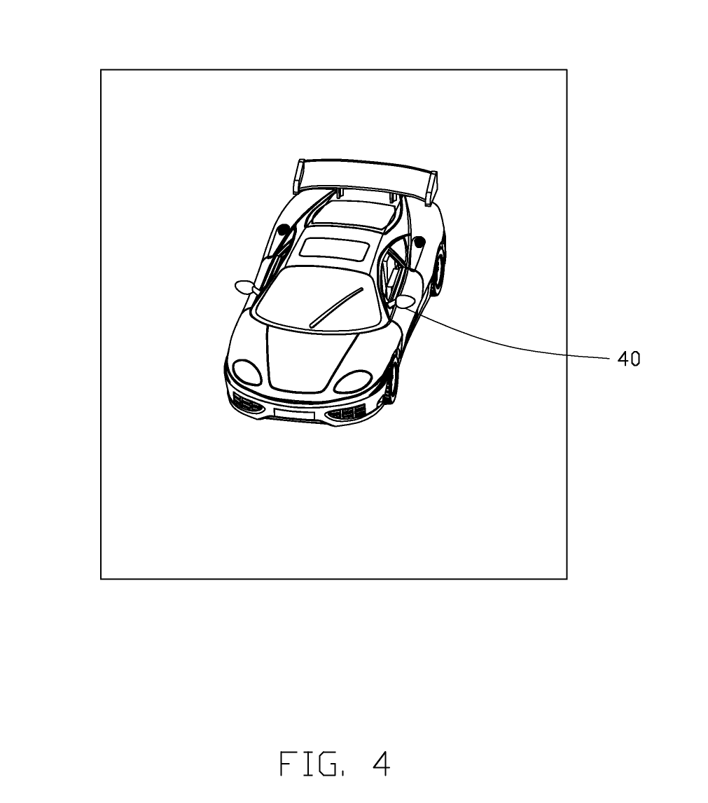

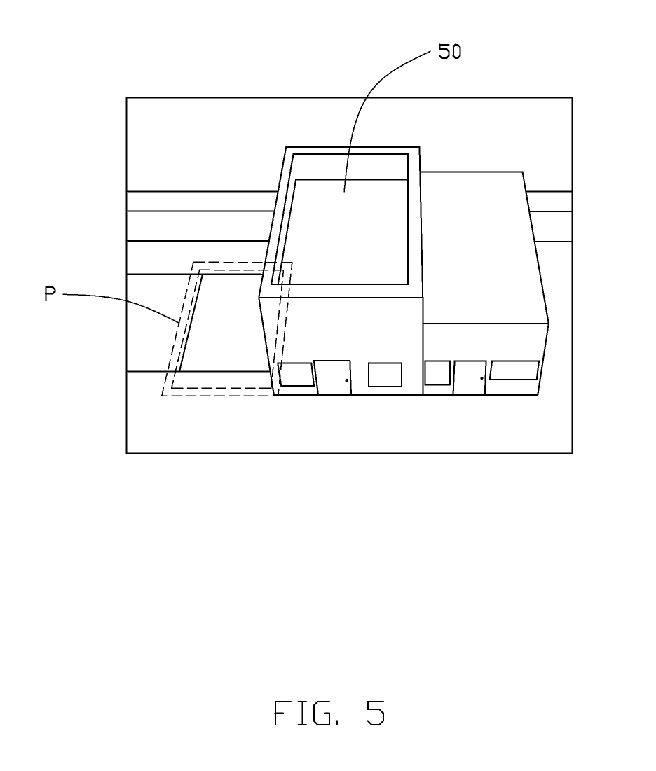

The modeling module 31 is configured to create a virtual object 40 (see FIG. 4) which can be stored in the storing module 32. The storing module 32 is configured to store the virtual object 40 and the surrounding images captured by the camera 10. The determining module 33 is configured to determine whether information of the virtual object 40 exists in a surrounding image captured by the camera 10. When the information of the virtual object 40 is in the surrounding image captured by the camera 10, the determining module 33 is configured to determine a shown preferred location. For example, the shown preferred location P for the virtual object 40 can be shown in FIG. 5.

The executing module 35 is configured to create an actual image 50 according to the surrounding image captured by the camera 10, when the information of the virtual object 40 is in the surrounding image.

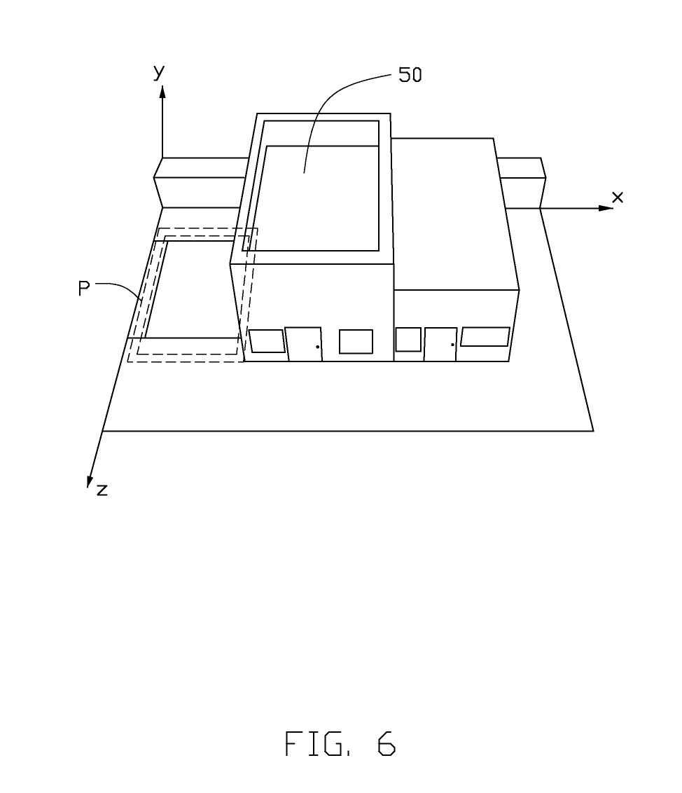

FIG. 6 illustrates the actual image 50 and the virtual object 40 being analyzed by the analyzing module 36. The analyzing module 36 is configured to analyze the actual image 50 to obtain the coordinate information of the virtual object 40 (see FIG. 6) according to the actual image 50, and the analyzing module 36 is further configured to analyze the light source and shadow angle of the preferred shown location P according to the coordinate information of the virtual object 40.

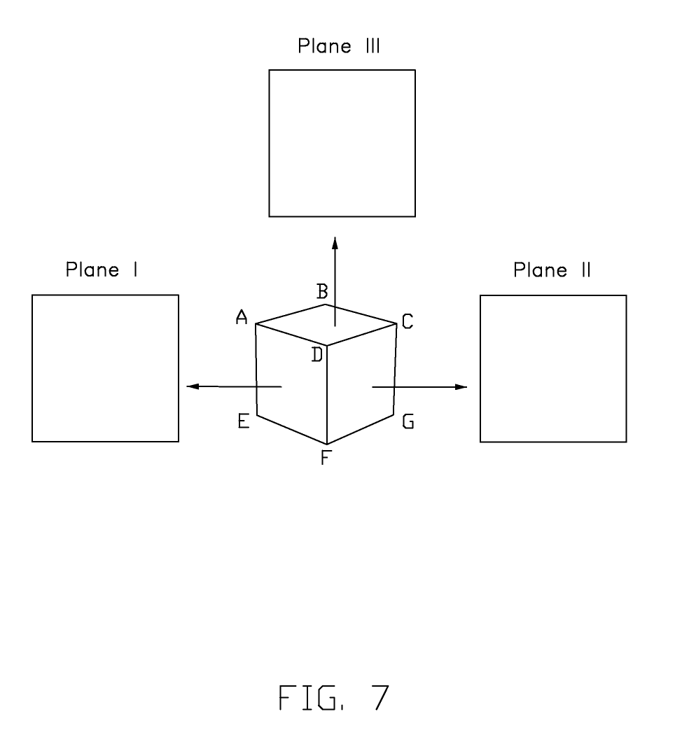

FIG. 7 illustrates an example of the light source and shadow angle of the virtual object 40 analyzed by the analyzing module 36. A virtual cube can be acted to be located on the preferred shown location P and can include a plurality of planes, such as a first plane I, a second plane II, and a third plane III.

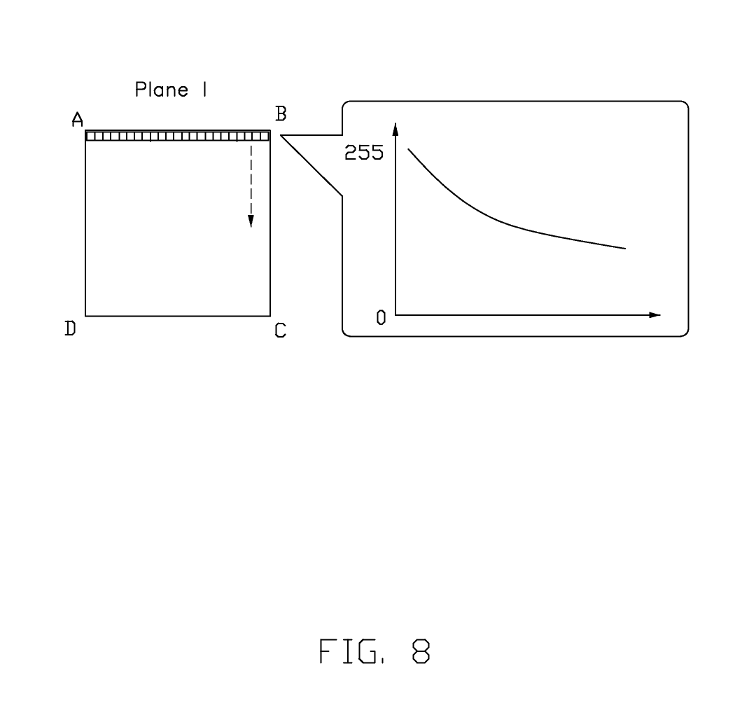

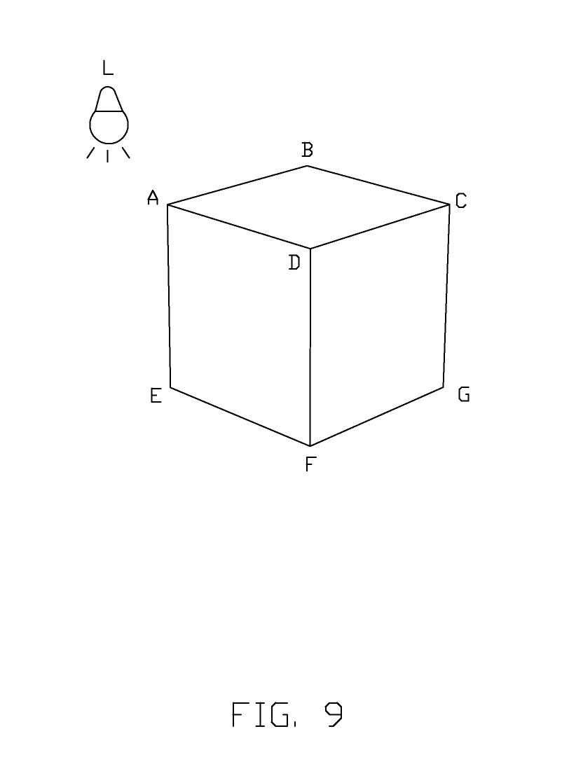

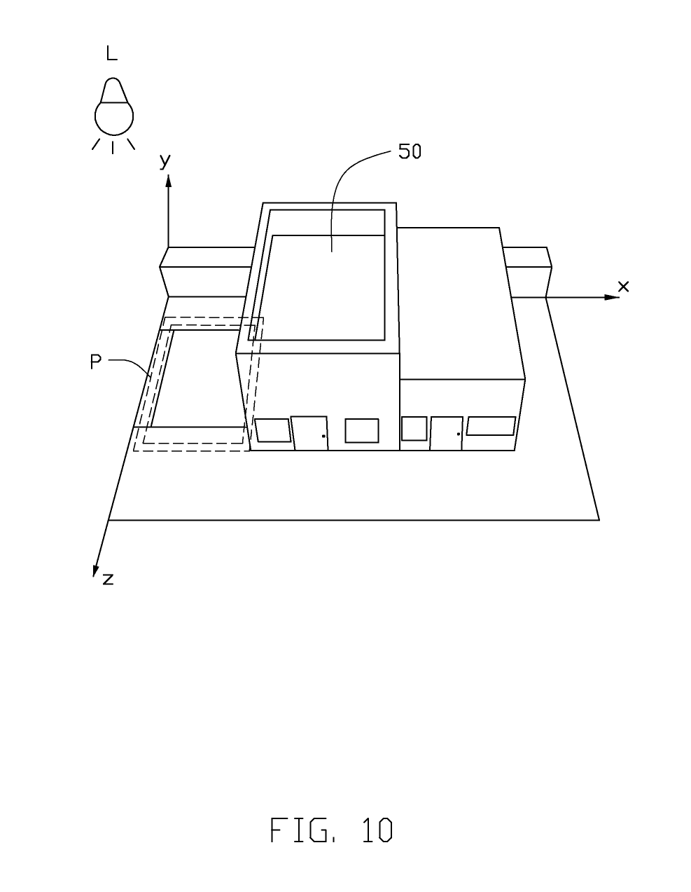

FIG. 8 illustrates the example of the light source and shadow angle of the first plane I analyzed by the analyzing module 36. The light source and shadow angle of each plane of the virtual cube can be analyzed by the analyzing module 36. For example, the first plane I can include a plurality of lines, each line can include a plurality of coordinate points, and each coordinate point can act as a pixel point. For example, the first line of the plurality of lines can include a plurality of pixel points. A pixel point value approaches 0, the color of the pixel point approaches black, conversely, the pixel point value approaches 255, the color of the pixel point approaches white. Therefore, a brightness of the pixel point A of the first line is greater than a brightness of the pixel point B of the first line. Similarly, the brightness of each pixel point of each plane of the virtual cube can be obtained by the analyzing module 36. When the analyzing module 36 obtains the brightness of each pixel point of each plane of the virtual cube; the analyzing module 36 can be configured to confirm the light source location, such as the light source location L (see FIGS. 9-10).

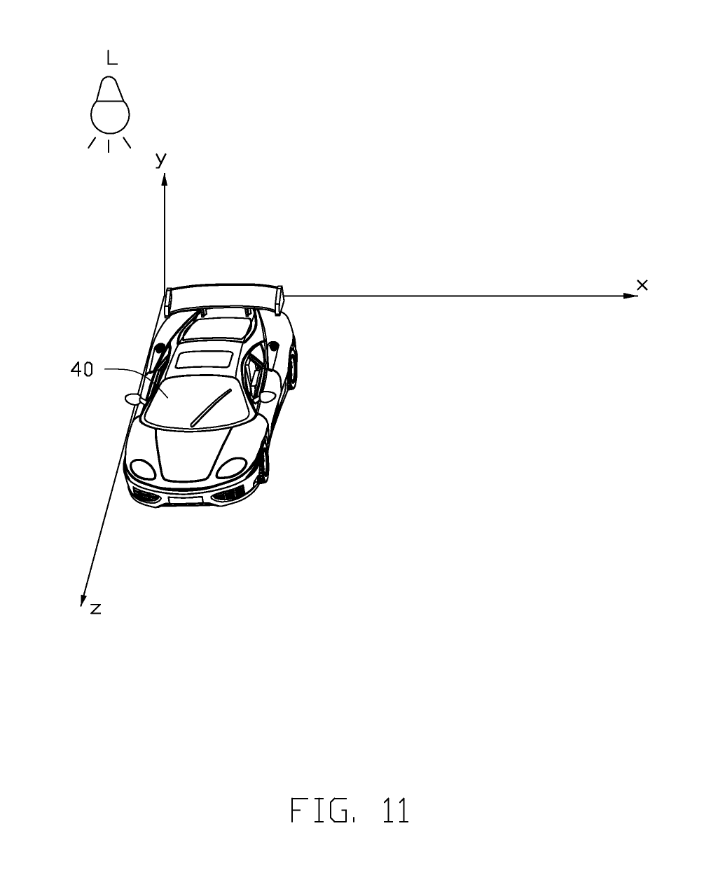

FIG. 11 illustrates the example of the coordinate point being confirmed of the virtual object 40 by the analyzing module 36. When the light source location L of the virtual cube is confirmed by the analyzing module 36, the analyzing module 36 can place light source location L of the virtual cube into the actual image 50 to obtain the coordinate point of the light source in the actual image 50. When the coordinate point of the light source in the actual image 50 is confirmed by the analyzing module 36, the light source and shadow angle of the actual image 50 can be confirmed by the analyzing module 36 according to the coordinate point of the light source.

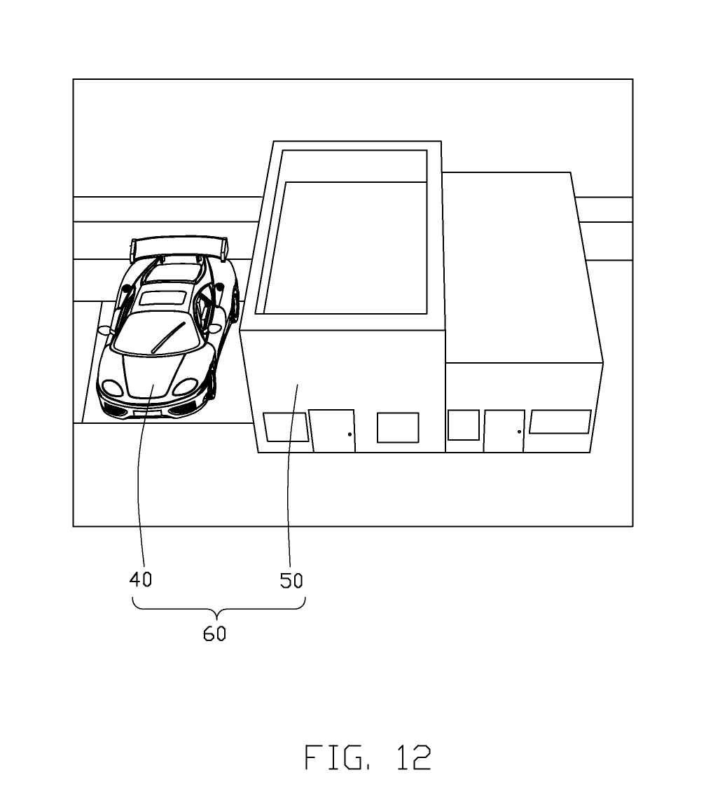

FIG. 12 illustrates the example of a composite image 60 including the actual image 50 and the virtual object 40. The adjusting module 37 is configured to adjust the light source and shadow angle of the virtual object 40 to ensure the light source and shadow angle of the virtual object 40 is consistent with the light source and shadow angle of the actual image 50. When the light source and shadow angle of the virtual object 40 is adjusted, the executing module 35 is further configured to add the virtual object 40 into the actual image 50, so that the composite image 60 is completed.

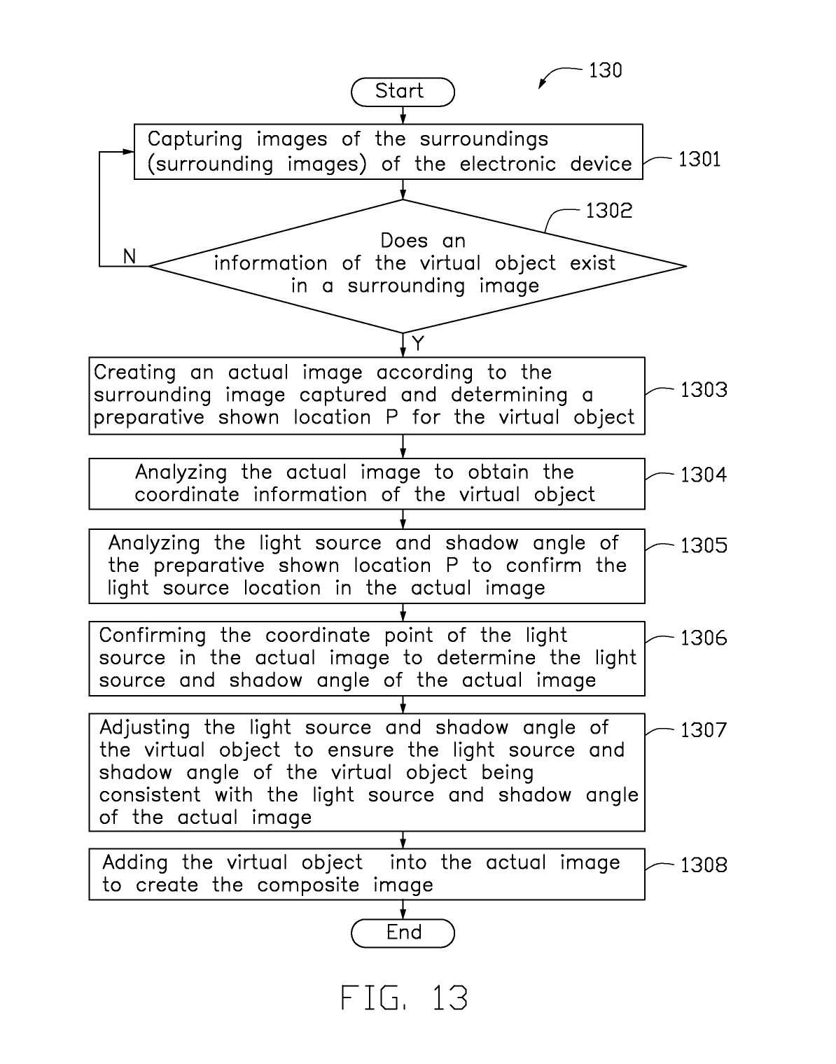

Referring to FIG. 13, a flowchart is presented in accordance with an example embodiment which is being thus illustrated. The example method 130 is provided by way of example, as there are a variety of ways to carry out the method. The method 130 described below can be carried out using the configurations illustrated in FIGS. 1-12, for example, and various elements of these figures are referenced in explaining example method 130. Each block shown in FIG. 13 represents one or more processes, methods, or subroutines, carried out in the exemplary method 130. Additionally, the illustrated order of blocks is by example only and the order of the blocks can change. Before the exemplary method 130, the modeling module 31 can create the virtual object 40 (see FIG. 4) to be stored in the storing module 32. The exemplary method 110 can begin at block 1301.

At block 1301, the camera 10 captures images of the surroundings (surrounding images) of the electronic device 30 to send to the determining module 33.

At block 1302, the determining module 33 determines whether information of the virtual object 40 exists in a surrounding image captured by the camera 10. If yes, goes on block 1303, if no, goes back block 1301.

At block 1303, the executing module 35 creates an actual image 50 according to the surrounding image captured by the camera 10, and the determining module 33 determines a preferred shown location P for the virtual object 40 according to the coordinate points of the actual image 50.

At block 1304, the analyzing module 36 analyzes the actual image 50 to obtain the coordinate information of the virtual object 40 (see FIG. 6) according to the actual image 50.

At block 1305, the analyzing module 36 analyzes the light source and shadow angle of the preferred shown location P according to the coordinate information of the virtual object 40 to confirm the light source location in the actual image 50.

At block 1306, the analyzing module 36 confirms the coordinate point of the light source in the actual image 50 to determine the light source and shadow angle of the actual image 50.

At block 1307, the adjusting module 37 adjusts the light source and shadow angle of the virtual object 40 to confirm the light source and shadow angle of the virtual object 40 is consistent with the light source and shadow angle of the actual image 50.

At block 1308, the executing module 35 adds the virtual object 40 into the actual image 50, and the actual image 50 displays the virtual object 40 in the composite image 60.

The embodiments shown and described above are only examples. Many details are often found in the art such as the other features of an augmented reality processing system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An augmented reality processing system comprising:
a camera configured to capture images of the surroundings of an electronic device, whereby surrounding images are created;
at least one microprocessor in the electronic device configured to:
determine whether an information of a virtual object exists in a surrounding image;
create an actual image when the information of the virtual object exists in a surrounding image;
analyze a light source and shadow angle of the actual image;
adjust a light source and shadow angle of the virtual object to ensure the light source and shadow angle of the virtual object are consistent with the light source and shadow angle of the actual image; and
create an composite image including the virtual object and the actual image.

2. The augmented reality processing system of claim 1, wherein the at least one microprocessor is also configured to determine a preferred shown location P for the virtual object according to the coordinate points of the actual image, and the at least one microprocessor is also configured to determine the light source and shadow angle of the preferred shown location P to confirm the light source location in the actual image.

3. The augmented reality processing system of claim 2, wherein the preferred shown location P comprises a virtual cube which comprising a plurality of planes, and the at least one microprocessor is configured to confirm the light source location according to the plurality of planes.

4. The augmented reality processing system of claim 3, wherein each plane comprises a plurality of lines, each line can include a plurality of coordinate point, each coordinate point can be acted as a pixel point, a pixel point value is approached 0, the color of the pixel point is approached black, conversely, the pixel point value is approached 255, the color of the pixel point is approached white, the brightness of each pixel point of each plane of the virtual cube can be obtained, and when the at least one microprocessor obtains the brightness of each pixel point of each plane of the virtual cube, the at least one microprocessor is configured to confirm the light source location.

5. The augmented reality processing system of claim 1, wherein the at least one microprocessor is configured to create the virtual object to be stored in a storage device.

6. The augmented reality processing system of claim 1, wherein the camera is a depth-sensing camera.

7. The augmented reality processing system of claim 1, wherein the electronic device is a notebook or a tablet personal computer.

8. An augmented reality processing method comprising:
(a) capturing images of the surroundings (surrounding images) of an electronic device,
(b) determining whether an information of a virtual object exists in a surrounding imagee;
(c) creating an actual image when the information of the virtual object exists in a surrounding image;
(d) analyzing a light source and shadow angle of the actual image;
(e) adjusting a light source and shadow angle of the virtual object to ensure the light source and shadow angle of the virtual object being consistent with the light source and shadow angle of the actual image; and
(f) creating an composite image including the virtual object and the actual image.

9. The augmented reality processing method of claim 8, wherein the step (d) comprises following step (d1): determining a preferred shown location P for the virtual object according to the coordinate points of the actual image and determining the light source and shadow angle of the preferred shown location P to confirm the light source location in the actual image.

10. The augmented reality processing method of claim 9, wherein the preferred shown location P comprises a virtual cube which comprising a plurality of planes, the step (d1) comprises following step (d11): confirming the light source location according to the plurality of planes.

11. The augmented reality processing method of claim 10, wherein each plane comprises a plurality of lines, each line can include a plurality of coordinate point, each coordinate point can be acted as a pixel point, a pixel point value is approached 0, the color of the pixel point is approached black, conversely, the pixel point value is approached 255, the color of the pixel point is approached white, the brightness of each pixel point of each plane of the virtual cube can be obtained, and when obtains the brightness of each pixel point of each plane of the virtual cube, confirms the light source location.

12. The augmented reality processing method of claim 8, wherein before the step (a) further comprises following step: creating the virtual object, and storing the virtual object and the actual image.

13. The augmented reality processing method of claim 8, wherein the camera is a depth-sensing camera.

14. The augmented reality processing method of claim 8, wherein the vehicle device is a car, a bus, a taxi, or a truck.
